(19) United States
(12) Patent Application Publication
(10) Pub. No.: US 2005/0241445 A1
(43) Pub. Date: Nov. 3, 2005

(54) Machine for cutting openings in a substrate

(76) Inventor: Johannes Georg Schaede, Wurzburg (DE)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 10/512,798

(22) PCT Filed: Apr. 30, 2003
(86) PCT No.: PCT/IB03/01769

§ 371 Date: Apr. 27, 2005

(30) Foreign Application Priority Data
May 6, 2002 (EP) 02405368.8

(51) Int. Cl. B26D 1/00

(52) U.S. Cl. 83/13

(57) ABSTRACT

The machine comprises at least a cutting tool (11) and a first cylinder (3) supporting said substrate (8) and driving said substrate with gripper means (5) around a first axis of rotation (6), a second cylinder (10) comprising the cutting tool (11) having the shape of said opening, said cutting cylinder (10) rotating around a second axis of rotation (12) parallel to the first axis of rotation. The second axis is mounted on lateral displacement means (22) to bring said second cylinder (10) in a cutting position with respect to the first cylinder (3). Evacuation means (15) are provided to evacuate the cut part (21) of the substrate (8).

The present invention concerns a device for cutting an opening, for example a window, in a planar substrate.

The present invention also concerns a process for cutting an opening, for example a window, in a planar substrate.

In the field of banknotes and securities, there has been increasing needs for security features protecting against counterfeiting. Indeed, in the past years, computers, scanners and copy machines have been extensively developed and today, it is possible to buy very performing devices at a reasonable price. Since these devices are more performing, it has been at the same time necessary to develop new and improved security features for securities, such as banknotes, checks, cards (i.e. credit cards), ID cards, passports etc. which would not allow them to be copied by standard computers or scanners, or even modern color copy machines.

Such security features include special inks with iridescent properties, so called optically variable inks, used to print specific patterns on the substrate of the note, optically variable devices (such as holograms, kinegrams) in the shape of metallized patches, or also specific patterns, such as moire patterns and other similar patterns, all of which are very difficult if not impossible to copy by actual machines, but, on the other hand, are easy to control visually.

Other security features include combinations of superimposed lines and/or patterns with colors, which are only visible under specific conditions, for example UV light or by transparency. Again, the interest of such security means is that they may easily be printed or placed on the document to be protected and also be controlled by simple devices, even visually, but they are impossible to reproduce with actual printers, scanners or copy machines.

Another specific technique involves watermarks in which the paper substrate is marked with lines or patterns only visible in transparency. A further development of this technique concerns pseudo-watermarks consisting in the creation of a window in the substrate, especially in paper-based substrates, which are normally not transparent, said window being transparent.

It is however very difficult to create or simulate a transparent window in a paper-based substrate. Transparent windows, as such, are widely used in polymer-based substrates for banknotes and securities, in order to provide a security element. These polymer-based substrates are usually completely transparent; therefore, to form a transparent window, it is only necessary to leave the chosen zone free of printing. However, in the case of paper, a substrate which is not transparent, a first process has been developed according to which, it is possible to reduce locally the thickness of the paper in order to create a transparent window in the substrate. PCT application WO 99/14433 for example, discloses this process and the content of this application is incorporated by reference in the present application. According to this known process, a soaking solution is applied on at least one surface of the paper in one or several predetermined zones, then one applies pressure and heat on the soaked zone so as to evaporate and densify the coated paper in said zone relative to the rest of the paper. Thus, said zones have a reduced thickness with respect to the rest of the paper and are transparent.

This first technique however has the drawback of weakening locally the paper in the zone comprising said window. In particular, the smaller the thickness of the window, the weaker the zone. Banknotes using such a technique thus have a reduced lifetime and must be exchanged, i.e. new bank notes must be printed to replace the older damaged ones.

Another technique implies to cut a hole directly in the substrate in order to create the transparent window. For example, PCT application WO 95/10420, the content of which is incorporated by reference in the present application, discloses a paper banknote with a cut window. It is of course necessary to cover the opening cut in the substrate, which is done in this case by a covering with a strip of transparent material, e.g. a foil or a laminate.

The aim of the invention is to improve the known machines and processes.

The aim of the invention is to provide an improved machine for cutting an opening in a planar substrate.

A further aim of the invention is to provide an improved process for cutting an opening in a planar substrate.

To fulfil these aims, the invention complies with the definition given in the claims.

The invention will best understood by the description of an embodiment and of the accompanying drawings in which:

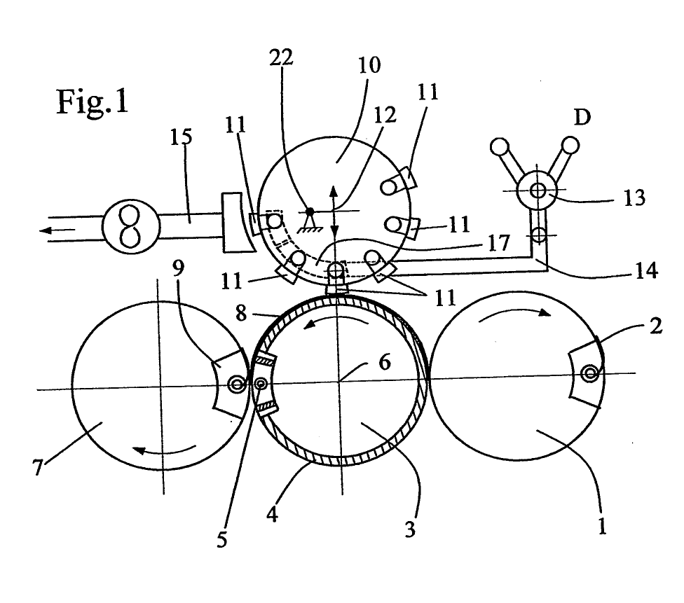

FIG. 1 shows a first embodiment of the machine according to the invention.

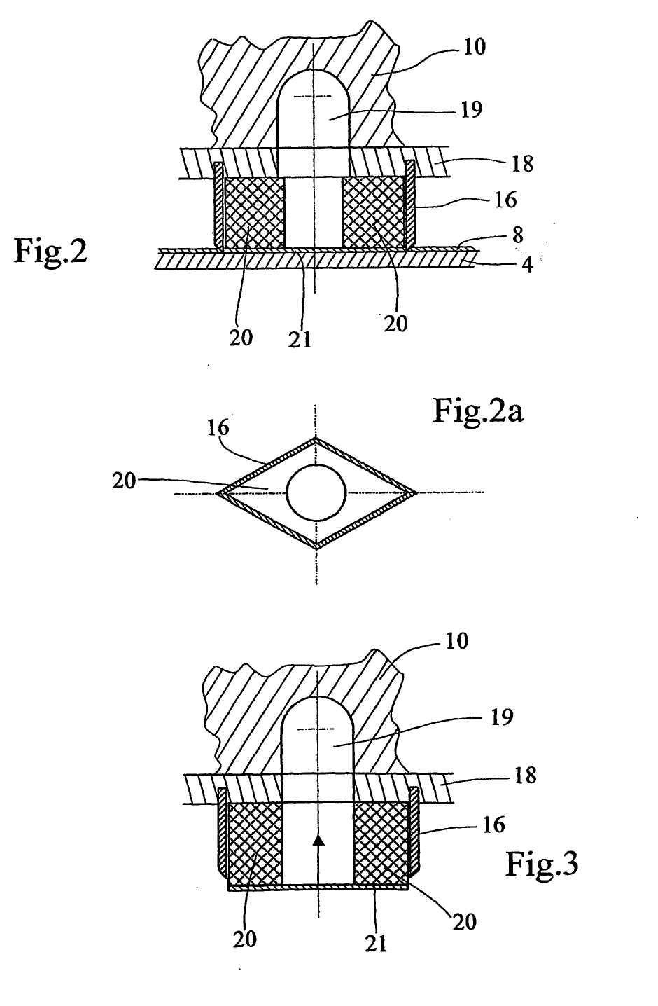

FIG. 2 shows a cross-sectional view of a cutting tool in cutting position.

FIG. 2a shows a bottom view of the cutting tool.

FIG. 3 shows a cross-sectional view of a cutting tool after an opening has been cut.

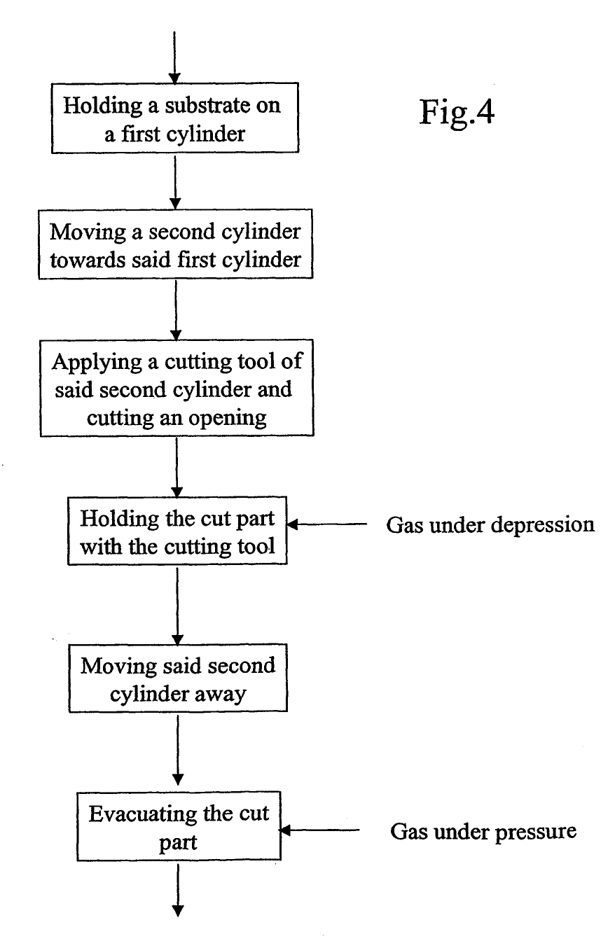

FIG. 4 shows a bloc-diagram of the process according to the invention.

The machine for cutting an opening in a planar substrate is firstly described in reference to FIG. 1. Said machine comprises a first transfer cylinder 1 holding a planar substrate, for example a sheet of paper, through first gripper means 2. The substrate 8 is transferred on a counter cylinder 3 and maintained on said cylinder 3 by second gripper means 5. Over the surface of the counter cylinder 3 und underneath the substrate 8, there is a layer of hard material 4 against which the cutting is made. Once the opening has been cut, the substrate 8 is transferred to a second transfer cylinder 7 and held on this cylinder 7 by gripper means 9. The gripper means 2, 5 and 9 are actuated for example by cams, in a manner known in the art, for example as disclosed in U.S. Pat. No. 5,125,336 incorporated by reference to the present application.

Above the counter cylinder 3, the cutting system is shown. This cutting system comprises a cutting cylinder 10, which carries several cutting tools 11 on its periphery. The cutting cylinder 10 rotates around an axis 12, which is parallel to the axis of cylinders 1, 3 and 7, and the cutting cylinder 10 is further movable in direction and away from the counter cylinder 3 in order to carry out the cutting operation. The cutting cylinder 10 is moved, for example, by displacing its axis 12 by means of eccentric bearings (for example as disclosed in U.S. Pat. No. 4,290,361, the principle of which are incorporated by reference in the present application), schematically represented in FIG. 1 by the reference 22 . Of course, any other equivalent means known in the art are possible.

In order to cut the opening with a cutting tool 11, the cutting cylinder 10 is displaced in the direction of the counter cylinder 3, the cutting tool 11 in contact with the counter cylinder 3 effectively cutting the opening in the substrate 8. The cutting operation will be explained in more detail with references to FIGS. 2 and 3 here below.

Once the opening has been cut out in the substrate 8, the cut part is held in the cutting tool 11 pressed against a soft part 20 (see FIG. 2) by a gas, for example air, under depression (position D) and brought to the tool 11 by valve 13 and corresponding channel 14. The air under depression is maintained in the tool 11 by a channel 19 in the cylinder 10 (see FIG. 2) coupling channel 14 with successive cutting tools 11 until the tool 11, by rotation of the cutting cylinder 10, reaches the evacuation system 15. To maintain the depression, a closed underpressure box 17 is placed against the cylinder 10 and keeps the depression in the channels 19 of each cutting tool 11 which holds a cut part or scrap 21 along the path followed by each tool until it reaches the evacuation system. At this point, the channel in the cylinder 10 corresponding to the cutting tool 11 in front of the evacuating system 15 is not coupled anymore to the channel 14 of gas under depression through box 17 so that the cut part may be aspirated by the evacuation system 15. According to a variant, air under pressure may be injected in the channel 19 of the cylinder 10 corresponding to the tool 11 facing the evacuation system 15 to make sure the cut part 21 is blown in the evacuation system 15.

As represented in FIG. 1, cutting cylinder 10 carries a plurality of cutting tools 11 distributed along the circumference of the cylinder 10. It is thus possible to cut several successive openings in the substrate at successive determined positions. This machine is accordingly suitable for cutting openings in sheets of substrate used for notes of securities, such as banknotes, on which the notes are printed in neighbouring rows and columns, in the shape of a matrix. By arranging the cutting tools 11 in corresponding rows and columns, it becomes possible to cut all necessary openings, i.e. one per printed note of a sheet of substrate 8, during one rotation of the counter cylinder 3.

The cutting tool is described in more details with reference to FIGS. 2, 2a and 3 in which, for the sake of clarity, only one tool 11 is represented. A part of the layer of hard material is shown at 4 over which the substrate 8 is held. The cutting tool 11 comprises a blade 16 , which has the shape of the opening to be cut. The blade 16 is held by a support 18 attached to the cutting cylinder 10 or formed by said cylinder 10. Cylinder channel 19 is connected to channel 14 (FIG. 1) to bring the air under depression or pressure in the tool 11. The tool 11 further comprises a soft part 20, for example an elastomer or rubber part, which dampens the displacement of the cutting cylinder 10 against the counter cylinder 3 and which also helps to eject the cut part.

In FIG. 2 further, the blade 16 is in a cutting position in that it is in the process of cutting an opening in substrate 8, thus forming a scrap 21 of substrate once the blade has gone through the substrate 8, this being effected by the relative lateral movement of the cutting cylinder 10 with respect to the counter cylinder 3, as shown in FIG. 1.

As represented in FIG. 2a, the cutting tool is, for example, diamond shaped with blades 16, soft part 20 and channel 19. This shape is only given as an example and other shapes are possible. Further, the blade 16 may be fabricated in one piece or in several pieces attached together.

Once the substrate 8 has been cut, and thus the opening formed, air under depression is fed into channel 19 thereby maintaining the scrap 21 of substrate 8 against the soft part 20. FIG. 3 shows a cutting tool 11 once the cutting has been done and the cutting cylinder 10 is rotating towards the evacuation system 15 (see FIG. 1). The cutting cylinder 10 is moved away from the counter cylinder 3, therefore the soft part 20 has a relaxed state in which it may project further than the edges of blades 16 and 17. Through the air under depression fed into channel 19, the scrap 21 of substrate 8 is maintained against the soft part 20 until the cutting cylinder reaches the evacuation system 15, whereby the valve 13 feeds then air under pressure in the channel 19 which blows the cut part or scrap 21 of substrate 8 in the evacuation system 15 (see FIG. 1).

The process according to the invention is described with reference to the bloc-diagram of FIG. 4.

First a sheet of planar substrate 8 is brought and held on a first cylinder, for example the counter cylinder 3. A second cylinder, cutting cylinder 20, carrying cutting tools 11 is moved towards the first cylinder until the cutting tool cuts an opening in the substrate 8. Once the cut carried out, the cut part (scrap of substrate 21) is maintained in the cutting tool 11 by application of a gas, i.e. air, under depression to the cutting tool 11. The second cylinder is then moved away from the first cylinder and, when it arrives in an evacuation position, gas (for example air) under pressure may be applied in the cutting tool 11 to blow the cut part in an evacuation system.

The embodiments of the invention described in the present specification are given as illustrative examples and must not be interpreted in a limiting manner. Other variants are possible within the scope of the claims.

1. A machine for cutting an opening, such as a window in a planar substrate, said machine comprising at least a cutting tool wherein it comprises
a first cylinder supporting said substrate and driving said substrate with gripper means around a first axis of rotation,
a second cylinder comprising the cutting tool having the shape of said opening, said cutting cylinder rotating around a second axis of rotation parallel to the first axis of rotation, said second axis being further mounted on lateral displacement means to bring said second cylinder in a cutting position with respect to the first cylinder, and
evacuation means to evacuate the cut part of said substrate.

2. The machine as claimed in claim 1, wherein said first cylinder comprises a hard material as outer layer.

3. The machine as claimed in claim 1, wherein said cutting tool comprises a punching tool having the shape of said opening.

4. The machine as claimed in claim 1, wherein said second cylinder comprises holding means to maintain the cut part of said substrate.

5. The machine as claimed in claim 1, wherein said holding means comprise a valve, said valve, in a first position, bringing air under depression to the punching tool to hold said cut part of substrate and, in a second position, bringing air under pressure to evacuate said cut part of substrate of the punching tool.

6. The machine as claimed in claim 1, wherein said cutting tool further comprises an elastomeric part.

7. The machine as claimed in claim 1, wherein said second cylinder comprises a plurality of cutting tools.

8. A process for cutting an opening, such as a window, in a planar substrate, said process being characterised by the following steps:
holding said substrate on a first cylinder,
moving a second cylinder towards said cylinder carrying the substrate,
applying a cutting tool attached to said second cylinder on said substrate and cutting said opening,
holding the cut part with the cutting tool,
moving said second cylinder away from said first cylinder, and
evacuating the cut part of said substrate.

9. The process according to claim 8, wherein the cutting of said opening is carried out by further movement of said second cylinder towards the first cylinder carrying the substrate.

10. The process according to claim 8, wherein the cut part is held by applying a gas under depression in said cutting tool.

11. The process according to claim 8, wherein the cut part is evacuated by applying a gas under pressure in said cutting tool.
